(19) United States
(12) Patent Application Publication
(10) Pub. No.: US 2018/0001274 A1
(43) Pub. Date: Jan. 4, 2018

(54) COMPOSITE SEMIPERMEABLE MEMBRANE, SPIRAL WOUND SEPARATION MEMBRANE ELEMENT, AND METHOD FOR PRODUCING THE SAME

(71) Applicant: NITTO DENKO CORPORATION, Osaka (JP)

(72) Inventors: Kazusa MATSUI, Osaka (JP); Nobuaki MARUOKA, Osaka (JP)

(73) Assignee: NITTO DENKO CORPORATION, Osaka (JP)

(21) Appl. No.: 15/545,111

(22) PCT Filed: Jan. 20, 2016
(86) PCT No.: PCT/JP2016/051584

§ 371 Date: Jul. 20, 2017

(30) Foreign Application Priority Data
Jan. 29, 2015 (JP) 2015-015898

(51) Int. Cl. B01D 69/12; B01D 69/10; B01D 63/10; C08G 69/26; B01D 71/56

(52) U.S. Cl. CPC B01D 69/125; C08G 69/26; B01D 71/56; B01D 63/10; B01D 69/10; B01D 2323/40

(57) ABSTRACT

The purpose of the present invention is to provide a composite semipermeable membrane whose water permeability is hard to decline even when exposed to high temperature environment for a long period of time, a spiral wound separation membrane element using the composite semipermeable membrane, and a method for producing the same. Another purpose of the invention is to provide a method for evaluating water permeation performance of a composite semipermeable membrane, which method evaluates whether the water permeability of a composite semipermeable membrane is likely to decline due to heat, by a simple evaluation method. The composite semipermeable membrane having a skin layer that includes a polyamide resin, the skin layer being placed on a porous support and having an elastic modulus of 100 MPa or more, calculated by AFM force curve measurement in water.

### TECHNICAL FIELD

The present invention relates to a composite semipermeable membrane wherein a skin layer containing a polyamide resin is formed on the surface of a porous support, a spiral wound separation membrane element using the composite semipermeable membrane, and a method for producing the same. The composite semipermeable membrane and the spiral wound separation membrane element are suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the membrane can be used for concentration of active ingredients in foodstuffs usage, for an advanced water treatment, such as removal of harmful component in water purification and sewage usage etc. Moreover, the membrane can be used for waste water treatment in oil fields or shale gas fields.

### BACKGROUND ART

The composite semipermeable membrane is called an RO (reverse osmosis) membrane, an NF (nanofiltration) membrane, or a FO (forward osmosis) membrane, depending on the filtration performance and treatment method of the membrane, and such membrane can be used for the production of ultrapure water, sea water desalination, desalination of brackish water, waste water recycling treatment, or the like.

Currently, composite semipermeable membranes, in which a skin layer including a polyamide resin obtained by interfacial polymerization of a polyfunctional amine and a polyfunctional acid halide is formed on a porous support, have been proposed (Patent Document 1).

The composite semipermeable membrane is usually processed into a spiral wound separation membrane element and used for water treatment and the like. For example, a spiral wound separation membrane element is known, the spiral wound separation membrane element including a unit that is formed of a feed spacer that guides a feed-side fluid to the surface of a separation membrane, a separation membrane that separates the feed-side fluid, and a permeate spacer that guides to the core tube a permeation-side fluid separated from the feed-side fluid by permeating through the separation membrane, and is wound around a perforated core tube (Patent Documents 2 and 3).

The spiral wound separation membrane element is often used in a high temperature area. In addition, since the produced spiral wound separation membrane element is usually transported by a ship, such a membrane element is exposed to a high temperature environment in the vicinity of the equator. If the spiral wound separation membrane element is exposed to a high temperature environment for a long period of time, there is a problem that the water permeability declines. For this reason, it was necessary to keep the spiral wound separation membrane element while preserving it under refrigeration in high temperature areas or it was necessary to transport the spiral wound separation membrane element while preserving it under refrigeration when transporting it by a ship. However, when the spiral wound separation membrane element is preserved under refrigeration, the cost is high and thus development of a spiral wound separation membrane element which does not require refrigerated storage is desired.

On the other hand, Patent Document 4 describes that a polyamide thin film is brought into contact with an aqueous solution of a temperature of 40 to 100° C. in order to obtain a composite reverse osmosis membrane excellent in water permeability, organic substance rejection performance and salt rejection performance.

In addition, Patent Document 5 describes that the membrane is heated in water at 40 to 100° C. for 30 seconds to 24 hours in order to reduce salt passage.

Further, Patent Document 6 describes that a thin film layer of a crosslinked polyamide is subjected to heat treatment in a range of 60 to 100° C. for 15 minutes or more in order to obtain a composite semipermeable membrane having both high temperature stability and high ion separation performance.

### PRIOR ART DOCUMENTS

### Patent Documents

Patent Document 1: JP-A-2005-103517

Patent Document 2: JP-A-2000-354743

Patent Document 3: JP-A-2006-68644

Patent Document 4: JP-A-H10-165790

Patent Document 5: JP-A-2001-521808

Patent Document 6: JP-A-2005-144211

### SUMMARY OF THE INVENTION

### Problems to be Solved by the Invention

The purpose of the invention is to provide a composite semipermeable membrane whose water permeability is hard to decline even when exposed to high temperature environment for a long period of time, a spiral wound separation membrane element using the composite semipermeable membrane, and a method for producing the same. Another purpose of the invention is to provide a method for evaluating water permeation performance of a composite semipermeable membrane, which method evaluates whether the water permeability of a composite semipermeable membrane is likely to decline due to heat, by a simple evaluation method.

### Means for Solving the Problem

The inventors of the invention have made extensive studies to solve the above-mentioned problems, and, as a result, have found that the purpose can be achieved by the following composite semipermeable membrane and have completed the invention.

That is, the present invention relates to a composite semipermeable membrane having a skin layer that includes a polyamide resin, the skin layer being placed on a porous support and having an elastic modulus of 100 MPa or more, calculated by AFM force curve measurement in water.

Although the composite semipermeable membrane is used in the presence of water, the physical properties of the skin layer in water, which is the actual use environment, have not been investigated. The present inventors have studied the physical properties of the skin layer in water by adopting a new analytical method, and, as a result, surprisingly found that when the skin layer having an elastic modulus of 100 MPa or more calculated by AFM (Atomic Force Microscope) force curve measurement in water is used, a composite semipermeable membrane which is hard to decline in water permeability is obtained even when exposed to high temperature environment (40° C. or more) for a long period (300 days or more). When the elastic modulus of the skin layer was measured in the air, the correlation between the decline in water permeability and the elastic modulus of the skin layer was not clear, but the correlation between the decline in water permeability and the elastic modulus of the skin layer became clear by adopting a new analytical technique based on the AFM force curve measurement in water.

The polyamide resin preferably contains a polymer of piperazine and trimesic acid chloride.

Also, the present invention relates to a method for producing a composite semipermeable membrane, comprising:

a step of contacting an amine solution containing a polyfunctional amine component and an organic solution containing a polyfunctional acid halide component on a porous support to form a skin layer containing the polyamide resin on the surface of the porous support,

wherein the contact is carried out in the presence of at least one substance having a solubility parameter of 8 to 14 (cal/cm³)^{1/2}, selected from ethanol, propanol, butanol, butyl alcohol, 1-pentanol, 2-pentanol, t-amyl alcohol, isoamyl alcohol, isobutyl alcohol, isopropyl alcohol, undecanol, 2-ethylbutanol, 2-ethylhexanol, octanol, cyclohexanol, tetrahydrofurfuryl alcohol, t-butanol, benzyl alcohol, 4-methyl-2-pentanol, 3-methyl-2-butanol, pentyl alcohol, allyl alcohol, anisole, ethyl isoamyl ether, ethyl-t-butyl ether, ethyl benzyl ether, crown ether, cresyl methyl ether, diisoamyl ether, diisopropyl ether, diglycidyl ether, cineol, diphenyl ether, dibutyl ether, dipropyl ether, dibenzyl ether, dimethyl ether, tetrahydropyran, trioxane, dichloroethyl ether, butyl phenyl ether, furan, monodichlorodiethyl ether, ethylene glycol dimethyl ether, ethylene glycol diethyl ether, ethylene glycol dibutyl ether, ethylene glycol monomethyl ether, ethylene glycol monoethyl ether, ethylene glycol monobutyl ether, diethylene glycol dimethyl ether, diethylene glycol diethyl ether, diethylene glycol dibutyl ether, diethylene glycol monomethyl ether, diethylene glycol monoethyl ether, diethylene glycol monobutyl ether and diethylene chlorohydrin, and

a step of applying warm water passing treatment to the skin layer after forming the skin layer on the surface of the porous support.

After forming the skin layer on the surface of a porous support, it is possible to form the skin layer having an elastic modulus of 100 MPa or more calculated by AFM force curve measurement in water by subjecting the skin layer to warm water passing treatment. Thereby, it is possible to obtain a composite semipermeable membrane which hardly reduces water permeability even when exposed to high temperature environment for a long time during storage or transportation. However, when warm water passing treatment is applied to the skin layer, the water permeability of the composite semipermeable membrane is reduced by about 10 to 20% due to the heat. Therefore, in the invention, by forming the skin layer in the presence of a substance having a solubility parameter of 8 to 14 (cal/cm3)^{1/2}, the initial water permeability of the composite semipermeable membrane is improved, and thus the decline in water permeability of the composite semipermeable membrane, which is caused by subjecting the skin layer to warm water passing treatment, is compensated. Although it is not clear why the elastic modulus of the skin layer in the measurement of the AFM force curve in water becomes 100 MPa or more by subjecting the skin layer to warm water passing treatment, it is considered that the crosslinked structure of the polyamide resin shrinks and regularly arranges due to the warm water passing treatment.

It is preferable to perform warm water passing treatment for 1 to 5 hours by using warm water of from 40° C. to 60° C. When the temperature of the warm water is less than 40° C., the elastic modulus of the skin layer tends not to be 100 MPa or more, whereas when the temperature of the warm water exceeds 60° C., the water permeability of the composite semipermeable membrane tends to be largely reduced. When the treatment time is less than 1 hour, the elastic modulus of the skin layer tends not to be 100 MPa or more, whereas even if the treatment time exceeds 5 hours, the effect of the warm water passing treatment is not affected, so that such a treatment time is disadvantageous from the viewpoint of production efficiency.

Further, it is preferable that the polyfunctional amine component is piperazine and the polyfunctional acid halide component is trimesic acid chloride.

Also, the present invention relates to a composite semipermeable membrane obtained by the production method, wherein the skin layer has an elastic modulus of 100 MPa or more calculated by AFM force curve measurement in water, and a spiral wound separation membrane element using the composite semipermeable membrane.

Also, the present invention relates to a method for producing a spiral wound separation membrane element, comprising:

a step of contacting an amine solution containing a polyfunctional amine component and an organic solution containing a polyfunctional acid halide component on a porous support to form a skin layer containing a polyamide resin on the surface of the porous support, thereby to prepare a composite semipermeable membrane,

wherein the contact is carried out in the presence of at least one substance having a solubility parameter of 8 to 14 (cal/cm³)^{1/2}, selected from ethanol, propanol, butanol, butyl alcohol, 1-pentanol, 2-pentanol, t-amyl alcohol, isoamyl alcohol, isobutyl alcohol, isopropyl alcohol, undecanol, 2-ethylbutanol, 2-ethylhexanol, octanol, cyclohexanol, tetrahydrofurfuryl alcohol, t-butanol, benzyl alcohol, 4-methyl-2-pentanol, 3-methyl-2-butanol, pentyl alcohol, allyl alcohol, anisole, ethyl isoamyl ether, ethyl-t-butyl ether, ethyl benzyl ether, crown ether, cresyl methyl ether, diisoamyl ether, diisopropyl ether, diglycidyl ether, cineol, diphenyl ether, dibutyl ether, dipropyl ether, dibenzyl ether, dimethyl ether, tetrahydropyran, trioxane, dichloroethyl ether, butyl phenyl ether, furan, monodichlorodiethyl ether, ethylene glycol dimethyl ether, ethylene glycol diethyl ether, ethylene glycol dibutyl ether, ethylene glycol monomethyl ether, ethylene glycol monoethyl ether, ethylene glycol monobutyl ether, diethylene glycol dimethyl ether, diethylene glycol diethyl ether, diethylene glycol dibutyl ether, diethylene glycol monomethyl ether, diethylene glycol monoethyl ether, diethylene glycol monobutyl ether and diethylene chlorohydrin,

a step of processing the composite semipermeable membrane into a spiral shape,and

a step of applying warm water passing treatment to the skin layer after processing the composite semipermeable membrane into a spiral shape.

According to the method for producing a spiral wound separation membrane element of the invention, such a membrane element incorporating a composite semipermeable membrane having a skin layer with an elastic modulus of 100 MPa or more, which is calculated by AFM force curve measurement in water, can be obtained with high production efficiency. The purpose of subjecting the skin layer to the warm water passing treatment and the purpose of forming the skin layer in the presence of a substance having a solubility parameter of 8 to 14 (cal/cm³)^{1/2} are as described above.

It is preferable to perform warm water passing treatment for 1 to 5 hours by using warm water of from 40° C. to 60° C. When the temperature of the warm water is less than 40° C., the elastic modulus of the skin layer tends not to be 100 MPa or more, whereas when the temperature of the warm water exceeds 60° C., the water permeability of the spiral wound separation membrane element tends to be largely reduced. When the treatment time is less than 1 hour, the elastic modulus of the skin layer tends not to be 100 MPa or more, whereas even if the treatment time exceeds 5 hours, the effect of the warm water passing treatment is not affected, so that such a treatment time is disadvantageous from the viewpoint of production efficiency.

Further, it is preferable that the polyfunctional amine component is piperazine and the polyfunctional acid halide component is trimesic acid chloride.

Also, the present invention relates to a spiral wound separation membrane element obtained by the production method, wherein the skin layer has an elastic modulus of 100 MPa or more calculated by AFM force curve measurement in water.

Further, the present invention relates to a method for evaluating water permeability of a composite semipermeable membrane, comprising:

calculating an elastic modulus of the skin layer of a composite semipermeable membrane having a skin layer including a polyamide resin on a porous support by AFM force curve measurement in water,

evaluating the water permeability of the composite semipermeable membrane as being hard to decline due to heat when the obtained elastic modulus value is 100 MPa or more, and

evaluating the water permeability of the composite semipermeable membrane as being likely to decline due to heat when the obtained elastic modulus value is less than 100 MPa.

### Effect of the Invention

The composite semipermeable membrane and the spiral wound separation membrane element of the invention are resistant to decline in water permeability, even in cases of extended exposure to a high-temperature environment. Therefore, the composite semipermeable membrane and the spiral wound separation membrane element of the invention do not require refrigerated storage during storage or transportation. As a result, the operation cost of the water treatment facility or the transportation cost to the water treatment facility can be reduced. Further, according to the method of evaluating the water permeation performance of the composite semipermeable membrane of the invention, it is possible to evaluate beforehand whether the water permeability of the composite semipermeable membrane is likely to decline due to heat, by a simple evaluation method.

### BRIEF DESCRIPTION OF THE DRAWINGS

FIG. 1 is a schematic configuration diagram showing a method of fixing a sample.

### MODE FOR CARRYING OUT THE INVENTION

The embodiments of the invention will be described below. The composite semipermeable membrane of the invention has a skin layer containing a polyamide resin on a porous support.

The polyamide resin can be obtained by reacting a polyfunctional amine component with a polyfunctional acid halide component.

The polyfunctional amine component is defined as a polyfunctional amine having two or more reactive amino groups, and includes aromatic, aliphatic, and alicyclic polyfunctional amines.

The aromatic polyfunctional amines include, for example, m-phenylenediamine, p-phenylenediamine, o-phenylenediamine, 1,3,5-triamino benzene, 1,2,4-triamino benzene, 3,5-diaminobenzoic acid, 2,4-diaminotoluene, 2,6-diaminotoluene, N,N′-dimethyl-m-phenylenediamine, 2,4-diaminoanisole, amidol, xylylene diamine etc.

The aliphatic polyfunctional amines include, for example, ethylenediamine, propylenediamine, tris(2-aminoethyl)amine, n-phenylethylenediamine, etc.

The alicyclic polyfunctional amines include, for example, 1,3-diaminocyclohexane, 1,2-diaminocyclohexane, 1,4-diaminocyclohexane, piperazine, 2,5-dimethylpiperazine, 4-aminomethyl piperazine, etc.

These polyfunctional amines may be used independently, and two or more kinds may be used in combination. Among them, piperazine, 2,5-dimethylpiperazine, or 4-aminomethylpiperazine is preferably used from the viewpoint of reactivity with the polyfunctional acid halide component, and it is more preferable to use piperazine.

The polyfunctional acid halide component represents polyfunctional acid halides having two or more reactive carbonyl groups.

The polyfunctional acid halides include aromatic, aliphatic, and alicyclic polyfunctional acid halides.

The aromatic polyfunctional acid halides include, for example trimesic acid trichloride, terephthalic acid dichloride, isophthalic acid dichloride, biphenyl dicarboxylic acid dichloride, naphthalene dicarboxylic acid dichloride, benzenetrisulfonic acid trichloride, benzenedisulfonic acid dichloride, chlorosulfonyl benzenedicarboxylic acid dichloride etc.

The aliphatic polyfunctional acid halides include, for example, propanedicarboxylic acid dichloride, butane dicarboxylic acid dichloride, pentanedicarboxylic acid dichloride, propane tricarboxylic acid trichloride, butane tricarboxylic acid trichloride, pentane tricarboxylic acid trichloride, glutaryl halide, adipoyl halide etc.

The alicyclic polyfunctional acid halides include, for example, cyclopropane tricarboxylic acid trichloride, cyclobutanetetracarboxylic acid tetrachloride, cyclopentane tricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofuran dicarboxylic acid dichloride, etc.

These polyfunctional acid halides may be used independently, and two or more kinds maybe used in combination. In order to obtain a skin layer having higher salt-rejecting property, it is preferred to use aromatic polyfunctional acid halides. In addition, it is preferred to form a cross linked structure using polyfunctional acid halides having trivalency or more as at least a part of the polyfunctional acid halide components. It is especially preferable to use trimesic acid trichloride.

Furthermore, in order to improve performance of the skin layer including the polyamide resin, polymers such as polyvinyl alcohol, polyvinylpyrrolidone, and polyacrylic acids etc., and polyhydric alcohols, such as sorbitol and glycerin, may be copolymerized.

The porous support for supporting the skin layer is not especially limited as long as it has a function for supporting the skin layer, and usually ultrafiltration membrane having micro pores with an average pore size approximately 10 to 500 angstroms may preferably be used. Materials for formation of the porous support include various materials, for example, polyarylether sulfones, such as polysulfones and polyether sulfones; polyimides; polyvinylidene fluorides; etc., and polysulfones and polyarylether sulfones are especially preferably used from a viewpoint of chemical, mechanical, and thermal stability. The thickness of this porous support is usually approximately 25 to 125 μm, and preferably approximately 40 to 75 μm, but the thickness is not necessarily limited to them. The porous support may be reinforced with backing by cloths, nonwoven fabric, etc.

Processes for forming the skin layer including the polyamide resin on the surface of the porous support is not in particular limited, and any publicly known methods may be used. For example, the publicly known methods include an interfacial condensation method, a phase separation method, a thin film application method, etc. The interfacial condensation method is a method, wherein an amine aqueous solution containing a polyfunctional amine component, an organic solution containing a polyfunctional acid halide component are forced to contact together to form a skin layer by an interfacial polymerization, and then the obtained skin layer is laid on a porous support, and a method wherein a skin layer of a polyamide resin is directly formed on a porous support by the above-described interfacial polymerization on a porous support. Details, such as conditions of the interfacial condensation method, are described in Japanese Patent Application Laid-Open No. S58-24303, Japanese Patent Application Laid-Open No. H01-180208, and these known methods are suitably employable.

In the invention, it is desirable to form a skin layer by a method of bringing an amine solution containing a polyfunctional amine component and an organic solution containing a polyfunctional acid halide component into contact with each other on a porous support to perform interfacial polymerization.

Although the concentration of the polyfunctional amine component in the amine solution is not in particular limited, the concentration is preferably 0.1 to 5% by weight, and more preferably 0.5 to 4% by weight. Less than 0.1% by weight of the concentration of the polyfunctional amine component may easily cause defect such as pinhole in the skin layer, leading to tendency of deterioration of salt rejection property. On the other hand, the concentration of the polyfunctional amine component exceeding 5% by weight allows easy permeation of the polyfunctional amine component into the porous support to be an excessively large thickness and to raise the permeation resistance, likely giving deterioration of the permeation flux.

Although the concentration of the polyfunctional acid halide component in the organic solution is not in particular limited, it is preferably 0.01 to 5% by weight, and more preferably 0.05 to 3% by weight. Less than 0.01% by weight of the concentration of the polyfunctional acid halide component is apt to make the unreacted polyfunctional amine component remain, to cause defect such as pinhole in the skin layer, leading to tendency of deterioration of salt rejection property. On the other hand, the concentration exceeding 5% by weight of the polyfunctional acid halide component is apt to make the unreacted polyfunctional acid halide component remain, to be an excessively large thickness and to raise the permeation resistance, likely giving deterioration of the permeation flux.

Examples of the solvents for the amine solution include water, alcohols (e.g. ethanol, isopropyl alcohol, and ethylene glycol), and a mixed solvent of water and an alcohol.

The solvent used for the organic solution is not especially limited as long as they have small solubility to water, and do not cause degradation of the porous support, and dissolve the polyfunctional acid halide component. For example, the solvents include saturated hydrocarbons, such as cyclohexane, heptane, octane, and nonane, halogenated hydrocarbons, such as 1,1,2-trichlorofluoroethane, etc. A saturated hydrocarbon or a naphthenic solvent, which has a boiling point of preferably 300° C. or less, more preferably 200° C. or less, is used as the solvent for the organic solution. The organic solvent may be used singly or as a mixed solvent of two or more kinds thereof.

In the invention, it is preferable to bring the amine solution and the organic solution into contact with each other in the presence of a substance having a solubility parameter of 8 to 14 (cal/cm³)^{1/2}.

The solubility parameter refers to an amount defined as (ΔH/V)^{1/2}(cal/cm³)^{1/2} when the molar evaporation heat of the liquid is AH cal/mol and the molar volume is V cm³/mol. Examples of the substance having a solubility parameter of 8 to 14 (cal/cm³)^{1/2} include alcohols, ethers, ketones, esters, halogenated hydrocarbons, sulfur-containing compounds, and the like.

Examples of the alcohols include ethanol, propanol, butanol, butyl alcohol, 1-pentanol, 2-pentanol, t-amyl alcohol, isoamyl alcohol, isobutyl alcohol, isopropyl alcohol, undecanol, 2-ethylbutanol, 2-ethylhexanol, octanol, cyclohexanol, tetrahydrofurfuryl alcohol, neopentyl glycol, t-butanol, benzyl alcohol, 4-methyl-2-pentanol, 3-methyl-2-butanol, pentyl alcohol, allyl alcohol, ethylene glycol, diethylene glycol, triethylene glycol, tetraethylene glycol, and the like.

Examples of the ethers include anisole, ethyl isoamyl ether, ethyl-t-butyl ether, ethyl benzyl ether, crown ether, cresyl methyl ether, diisoamyl ether, diisopropyl ether, diethyl ether, dioxane, diglycidyl ether, cineol, diphenyl ether, dibutyl ether, dipropyl ether, dibenzyl ether, dimethyl ether, tetrahydropyran, tetrahydrofuran, trioxane, dichloroethyl ether, butyl phenyl ether, furan, methyl-t-butyl ether, monodichloro diethyl ether, ethylene glycol dimethyl ether, ethylene glycol diethyl ether, ethylene glycol dibutyl ether, ethylene glycol monomethyl ether, ethylene glycol monoethyl ether, ethylene glycol monobutyl ether, diethylene glycol dimethyl ether, diethylene glycol diethyl ether, diethylene glycol dibutyl ether, diethylene glycol monomethyl ether, diethylene glycol monoethyl ether, diethylene glycol monobutyl ether, diethylene chlorohydrin, and the like.

Examples of the ketones include ethyl butyl ketone, diacetone alcohol, diisobutyl ketone, cyclohexanone, 2-heptanone, methyl isobutyl ketone, methyl ethyl ketone, methyl cyclohexanone, and the like.

Examples of the esters include methyl formate, ethyl formate, propyl formate, butyl formate, isobutyl formate, isoamyl formate, methyl acetate, ethyl acetate, propyl acetate, butyl acetate, isobutyl acetate, amyl acetate, and the like.

Examples of the halogenated hydrocarbons include allyl chloride, amyl chloride, dichloromethane, dichloroethane, and the like.

Examples of the sulfur-containing compounds include dimethyl sulfoxide, sulfolane, thiolane, and the like.

Of these, alcohols and ethers are particularly preferable. These may be used singly, or two or more of them may be used in combination.

The substance having a solubility parameter of 8 to 14 (cal/cm³)^{1/2} may be added to the amine solution, added to the organic solution, or added to both solutions. Further, the porous support may be impregnated with such a substance in advance. In addition, the amine solution and the organic solution may be brought into contact with each other on the porous support in a gas atmosphere of the substance.

When the substance is added to the amine solution, the addition amount is preferably 10 to 50% by weight. If the addition amount of the substance to the amine solution is less than 10% by weight, the effect of increasing the permeation flux is insufficient, and when the addition amount of the substance to the amine solution exceeds 50% by weight, the rejection rate tends to decrease. When the substance is added to the organic solution, the addition amount is preferably 0.001 to 10% by weight. If the addition amount of the substance to the organic solution is less than 0.001% by weight, the effect of increasing the permeation flux is insufficient, and when the addition amount of the substance to the organic solution exceeds 10% by weight, the rejection rate tends to decrease.

Various kinds of additives may be added to the amine solution or the organic solution in order to provide easy film production and to improve performance of the composite semipermeable membrane to be obtained. The additives include, for example, surfactants, such as sodium dodecylbenzenesulfonate, sodium dodecyl sulfate, and sodium lauryl sulfate; basic compounds, such as sodium hydroxide, trisodium phosphate, triethylamine, etc. for removing hydrogen halides formed by polymerization; acylation catalysts.

The period of time after application of the amine solution until application of the organic solution on the porous support depends on the composition and viscosity of the amine solution, and on the pore size of the surface layer of the porous support, and it is preferably 15 seconds or less, and more preferably 5 seconds or less. Application interval of the solution exceeding 15 seconds may allow permeation and diffusion of the amine solution to a deeper portion in the porous support, and possibly cause a large amount of the residual unreacted polyfunctional amine components in the porous support. In this case, removal of the unreacted polyfunctional amine component that has permeated to the deeper portion in the porous support is probably difficult even with a subsequent membrane washing treatment. Excessive amine solution may be removed after covering by the amine solution on the porous support.

In the present invention, after the contact with the amine solution and the organic solution, it is preferred to remove the excessive organic solution on the porous support, and to dry the formed membrane on the porous support by heating at a temperature of 70° C. or more, forming the skin layer. Heat-treatment of the formed membrane can improve the mechanical strength, heat-resisting property, etc. The heating temperature is more preferably 70 to 200° C., and especially preferably 100 to 150° C. The heating period of time is preferably approximately 30 seconds to 10 minutes, and more preferably approximately 40 seconds to 7 minutes.

The thickness of the skin layer formed on the porous support is not in particular limited, and it is usually approximately 0.05 to 2 μm, and preferably 0.1 to 1 μm.

Further, conventionally known various treatments may be applied to the composite semipermeable membrane so as to improve its salt rejection property, water permeability, and oxidation resistance.

In the invention, after forming the skin layer on the surface of the porous support, warm water passing treatment is applied to the skin layer. The temperature of warm water used for the warm water passing treatment is not particularly limited, but it is usually about 40 to 65° C. and preferably 40 to 60° C. There is no particular limitation on the time of the warm water passing treatment, but the time required for such treatment is preferably 1 to 5 hours, more preferably 3 to 5 hours. The warm water passing treatment may be performed on a film-like composite semipermeable membrane or may be performed on a spiral wound separation membrane element obtained by processing the composite semipermeable membrane into a spiral shape.

The spiral wound separation membrane element is produced, for example, by stacking a permeate spacer onto a material obtained by disposing a feed spacer between two sheets of a two-folded composite semipermeable membrane; applying an adhesive on the composite semipermeable membrane peripheral parts (three sides) so as to form sealing parts for preventing the feed-side fluid and the permeation-side fluid from being mixed with each other, thereby to prepare a separation membrane unit; winding one of the unit or a plurality of the units in a spiral form around a core tube, and further sealing the separation membrane unit peripheral parts.

The skin layer obtained by the above production method has an elastic modulus of 100 MPa or more calculated by AFM force curve measurement in water. The elastic modulus is preferably 110 MPa or more, more preferably 130 MPa or more, still more preferably 150 MPa or more.

Calculation of the elastic modulus of the skin layer by AFM force curve measurement in water is carried out by the method described in the Examples.

Also, based on the value of the elastic modulus of the skin layer calculated by the AFM force curve measurement in water, it is possible to evaluate in advance whether the water permeability of the composite semipermeable membrane is likely to decline when such membrane is exposed to a high temperature environment for a long time. Specifically, the elastic modulus of the skin layer of the composite semipermeable membrane is calculated by AFM force curve measurement in water, and when the value of the elastic modulus obtained is 100 MPa or more, the composite semipermeable membrane can be evaluated as its water permeability being hard to decline due to heat. When the value of the elastic modulus obtained is less than 100 MPa, the composite semipermeable membrane can be evaluated as its water permeability being likely to decline due to heat.

### EXAMPLE

The present invention will, hereinafter, be described with reference to Examples, but the present invention is not limited at all by these Examples.

### Evaluation and Measurement Method

### (Calculation of Elastic Modulus of Skin Layer by AFM Force Curve Measurement in Water)

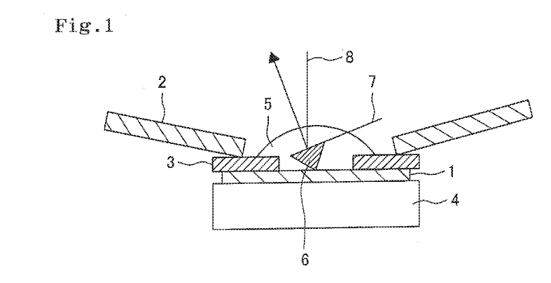

Sample 1 of the produced composite semipermeable membrane that was cut in a wet state into a size of 2 cm×2 cm was fixed on a glass plate 4 as a fixing jig as shown in FIG. 1, with use of a fixing jig for the measurement in a liquid (Closed Fluid Cell) manufactured by Asylum Technology Co., Ltd., a fixing pin 2, and a holding plate 3. Thereafter, about 100 μl of ultrapure water 5 was dropped onto the sample 1.

Then, the sample 1 was moved in the vertical direction, and a spherical probe 6 was pushed into the skin layer of the sample 1 while applying a load thereto. Subsequently, the deflection or warpage (displacement) of a cantilever 7 when it was pulled off was detected as the displacement of a laser light 8 with a photodiode to measure the force curve, which was then converted into the load and skin layer deformation amount using a program that was attached to the device. The region of the measurement area of 90 μm×90 μm was divided into 20×20, and the force curve was measured at a total of 400 points. Then, the average value of the skin layer deformation amount when the load was 3 μN was obtained.

The measuring device and measurement conditions are as follows.

Measuring device: MFP-3D (manufactured by Asylum Technology Co., Ltd.)

Cantilever: Spring constant 40 N/m

Spherical probe: manufactured by Nano Sensors Inc., tip curvature radius 0.4 μm, Silicon (100), Poisson's ratio 0.17, elastic modulus 150 GPa.

Measurement environment: in ultrapure water

Push-in speed, pull-off speed: 4.0 μm/s

Maximum load: 3 μN

Number of measurements n: 400

The elastic modulus Eₛₐₘₚₗₑ (MPa) of the skin layer can be obtained by substituting each numerical value into the Hertzian elastic contact theory formula described below.

h=[¾[{(1−v_{probe}²)/E_{probe}}+{(1−vₛₐₘₚₗₑ²)/Eₛₐₘₚₗₑ}]]^{2/3}F^{2/3}r^{-1/3}

h: Skin layer deformation amount (average value)

v_{probe}: Poisson's ratio of probe 0.17

vₛₐₘₚₗₑ: Poisson's ratio of sample 0.35 (0.35 is adopted as a representative value of resin (fixed value))

E_{probe}: Elastic modulus of probe 150 GPa

Eₛₐₘₚₗₑ: Elastic modulus of sample (MPa)

F: Load 3 μN

r: Tip curvature radius of probe 0.4 μm

### (Decreasing Rate of Permeation Flux)

A sample obtained by cutting the prepared composite semipermeable membrane into a predetermined shape and size is set in a flat membrane evaluation cell. An aqueous solution containing 0.2% MgSO₄ and adjusted to pH 6.5 to 7.0 with NaOH is brought into contact with the membrane at 25° C. by applying a differential pressure of 0.9 MPa to the feed side and the permeation side of the membrane. The permeation rate of the permeated water obtained by this operation was measured and the permeation flux X (m³/m²·d) was calculated from water permeability (cubic meter) per day per 1 m² of the membrane area. The sample was stored in an environment at 40° C. for 7 days, and thereafter the permeation flux Y was calculated by the same method. The decreasing rate of the permeation flux was calculated by the following equation.

Decreasing rate of permeation flux (%)=[(X−Y)/X]×100

### Comparative Example 1

An amine solution was prepared by dissolving 3.6% by weight of piperazine heptahydrate, 0.15% by weight of sodium lauryl sulfate, 6% by weight of camphor sulfonic acid, and 1.48% by weight of sodium hydroxide in water. Then, the amine solution was contacted with the surface of a porous support, and the excess amine solution was removed. Thereafter, the amine solution on the surface of the porous support was brought into contact with an organic solution in which 0.42% by weight of trimesic acid chloride and 0.5% by weight of t-butanol were dissolved in IP 1016 (boiling point 106° C.). Then, the excessive organic solution was removed and the residue was kept in a hot air dryer at 120° C. for 3 minutes to form a skin layer containing a polyamide resin on the porous support, thereby to prepare a composite semipermeable membrane.

### Example 1

The skin layer was subjected to warm water passing treatment by passing warm water of 40° C. for 5 hours through the composite semipermeable membrane prepared in Comparative Example 1.

### Example 2

The skin layer was subjected to warm water passing treatment bypassing warm water of 50° C. for 5 hours through the composite semipermeable membrane prepared in Comparative Example 1.

### Example 3

The skin layer was subjected to warm water passing treatment bypassing warm water of 60° C. for 5 hours through the composite semipermeable membrane prepared in Comparative Example 1.

### Example 4

A spiral wound separation membrane element was prepared using the composite semipermeable membrane prepared in Comparative Example 1. Warm water of 60° C. was passed through the prepared spiral wound separation membrane element for 3 hours, so that warm water passing treatment was applied onto the skin layer. In measuring the elastic modulus and the permeation flux, the composite semipermeable membrane was taken out from the element and then measured.

TABLE 1

| | | | Decreasing rate |
|---|---|---|---|
| | Warm water | Elastic modulus | of permeation |
| | passing treatment | (MPa) | flux (%) |
| Comparative | None | 75 | 19 |
| example 1 | | | |
| Example 1 | 40° C., 5 hours | 118 | 6 |
| Example 2 | 50° C., 5 hours | 115 | 5 |
| Example 3 | 60° C., 5 hours | 110 | 3 |
| Example 4 | 60° C., 3 hours | 158 | 2 |

### INDUSTRIAL APPLICABILITY

The composite semipermeable membrane and spiral wound separation membrane element of the present invention are suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the element can be used for concentration of active ingredients in foodstuffs usage, for an advanced water treatment, such as removal of harmful component in water purification and sewage usage etc. Moreover, the element can be used for waste water treatment in oil fields or shale gas fields.

### DESCRIPTION OF REFERENCE SIGNS

1: Sample

2: Fixing pin

3: Holding plate

4: Glass plate as a fixing jig

5: Ultrapure water

6: Spherical probe

7: Cantilever

8: Laser light

1. A composite semipermeable membrane having a skin layer that includes a polyamide resin, the skin layer being placed on a porous support and having an elastic modulus of 100 MPa or more, calculated by AFM force curve measurement in water.

2. The composite semipermeable membrane according to claim 1, wherein the polyamide resin comprises a polymer of piperazine and trimesic acid chloride.

3. A method for producing a composite semipermeable membrane, comprising:
a step of contacting an amine solution containing a polyfunctional amine component and an organic solution containing a polyfunctional acid halide component on a porous support to form a skin layer containing the polyamide resin on the surface of the porous support,
wherein the contact is carried out in the presence of at least one substance having a solubility parameter of 8 to 14 (cal/cm³)^{1/2}, selected from ethanol, propanol, butanol, butyl alcohol, 1-pentanol, 2-pentanol, t-amyl alcohol, isoamyl alcohol, isobutyl alcohol, isopropyl alcohol, undecanol, 2-ethylbutanol, 2-ethylhexanol, octanol, cyclohexanol, tetrahydrofurfuryl alcohol, t-butanol, benzyl alcohol, 4-methyl-2-pentanol, 3-methyl-2-butanol, pentyl alcohol, allyl alcohol, anisole, ethyl isoamyl ether, ethyl-t-butyl ether, ethyl benzyl ether, crown ether, cresyl methyl ether, diisoamyl ether, diisopropyl ether, diglycidyl ether, cineol, diphenyl ether, dibutyl ether, dipropyl ether, dibenzyl ether, dimethyl ether, tetrahydropyran, trioxane, dichloroethyl ether, butyl phenyl ether, furan, monodichlorodiethyl ether, ethylene glycol dimethyl ether, ethylene glycol diethyl ether, ethylene glycol dibutyl ether, ethylene glycol monomethyl ether, ethylene glycol monoethyl ether, ethylene glycol monobutyl ether, diethylene glycol dimethyl ether, diethylene glycol diethyl ether, diethylene glycol dibutyl ether, diethylene glycol monomethyl ether, diethylene glycol monoethyl ether, diethylene glycol monobutyl ether and diethylene chlorohydrin, and
a step of applying warm water passing treatment to the skin layer after forming the skin layer on the surface of the porous support.

4. The method for producing a composite semipermeable membrane according to claim 3, wherein the warm water passing treatment is carried out using warm water of 40 to 60° C. for 1 to 5 hours.

5. The method for producing a composite semipermeable membrane according to claim 3, wherein the polyfunctional amine component is piperazine and the polyfunctional acid halide component is trimesic acid chloride.

6. A composite semipermeable membrane obtained by the production method according to claim 3, wherein the skin layer has an elastic modulus of 100 MPa or more calculated by AFM force curve measurement in water.

7. A spiral wound separation membrane element using the composite semipermeable membrane according to claim 1.

8. A method for producing a spiral wound separation membrane element, comprising:
a step of contacting an amine solution containing a polyfunctional amine component and an organic solution containing a polyfunctional acid halide component on a porous support to form a skin layer containing a polyamide resin on the surface of the porous support, thereby to prepare a composite semipermeable membrane,
wherein the contact is carried out in the presence of at least one substance having a solubility parameter of 8 to 14 (cal/cm³)^{1/2}, selected from ethanol, propanol, butanol, butyl alcohol, 1-pentanol, 2-pentanol, t-amyl alcohol, isoamyl alcohol, isobutyl alcohol, isopropyl alcohol, undecanol, 2-ethylbutanol, 2-ethylhexanol, octanol, cyclohexanol, tetrahydrofurfuryl alcohol, t-butanol, benzyl alcohol, 4-methyl-2-pentanol, 3-methyl-2-butanol, pentyl alcohol, allyl alcohol, anisole, ethyl isoamyl ether, ethyl-t-butyl ether, ethyl benzyl ether, crown ether, cresyl methyl ether, diisoamyl ether, diisopropyl ether, diglycidyl ether, cineol, diphenyl ether, dibutyl ether, dipropyl ether, dibenzyl ether, dimethyl ether, tetrahydropyran, trioxane, dichloroethyl ether, butyl phenyl ether, furan, monodichlorodiethyl ether, ethylene glycol dimethyl ether, ethylene glycol diethyl ether, ethylene glycol dibutyl ether, ethylene glycol monomethyl ether, ethylene glycol monoethyl ether, ethylene glycol monobutyl ether, diethylene glycol dimethyl ether, diethylene glycol diethyl ether, diethylene glycol dibutyl ether, diethylene glycol monomethyl ether, diethylene glycol monoethyl ether, diethylene glycol monobutyl ether and diethylene chlorohydrin,
a step of processing the composite semipermeable membrane into a spiral shape,and
a step of applying warm water passing treatment to the skin layer after processing the composite semipermeable membrane into a spiral shape.

9. The method for producing a spiral wound separation membrane element according to claim 8, wherein the warm water passing treatment is carried out using warm water of 40 to 60° C. for 1 to 5 hours.

10. The method for producing a spiral wound separation membrane element according to claim 8, wherein the polyfunctional amine component is piperazine and the polyfunctional acid halide component is trimesic acid chloride.

11. A spiral wound separation membrane element obtained by the production method according to claim 8, wherein the skin layer has an elastic modulus of 100 MPa or more calculated by AFM force curve measurement in water.

12. A method for evaluating water permeability of a composite semipermeable membrane, comprising:
calculating an elastic modulus of the skin layer of a composite semipermeable membrane having a skin layer including a polyamide resin on a porous support by AFM force curve measurement in water,
evaluating the water permeability of the composite semipermeable membrane as being hard to decline due to heat when the obtained elastic modulus value is 100 MPa or more, and
evaluating the water permeability of the composite semipermeable membrane as being likely to decline due to heat when the obtained elastic modulus value is less than 100 MPa.
